(19) United States
(12) Patent Application Publication
(10) Pub. No.: US 2021/0102886 A1
(43) Pub. Date: Apr. 8, 2021

(54) SYSTEMS AND METHODS FOR AUTOMATED CLASSIFICATION OF SUBTYPING OF LEUKEMIA CELLS

(71) Applicants: University of Pittsburgh-Of the Commonwealth System of Higher Education, Pittsburgh, PA (US); National Taiwan University, Taipei (TW)

(72) Inventors: Sara Monaghan, Pittsburgh, PA (US); Michael Boyiadzis, Pittsburgh, PA (US); Steven H. Swerdlow, Pittsburgh, PA (US); Yen-Chun Liu, Pittsburgh, PA (US); Bor-Sheng KO, Taipei (TW); Yu-Fen Wang, Taipei (TW); Chi-Chun Lee, Hsinchu City (TW); Jeng-Lin Li, Hsinchu City (TW); Ming-Ya Ko, Hsinchu City (TW)

(21) Appl. No.: 17/064,568

(22) Filed: Oct. 6, 2020

Related U.S. Application Data
(60) Provisional application No. 62/911,313, filed on Oct. 6, 2019.

(51) Int. Cl. G01N 15/14

(52) U.S. Cl. CPC G01N 15/147; G01N 15/1429; G01N 2015/1402; G01N 2015/1493; G01N 2015/1486; G01N 2015/1488; G01N 2015/1477

(57) ABSTRACT

This application relates generally to automated systems and methods for classifying subtypes of leukemia cells and other applications therefrom.

### BACKGROUND

This application relates generally to automated systems and methods for classifying subtypes of leukemia cells based on flow cytometry (FC) data and other applications therefrom.

Flow cytometry immunophenotypic analysis is a critical component for establishing the diagnosis of hematolymphoid neoplasms and for monitoring therapeutic response of patients with these diseases. FC is powerful because it simultaneously characterizes per cell the expression of multiple antigens and physical light scatter properties for thousands or millions of hematolymphoid cells.

### SUMMARY

The exemplary embodiments disclosed herein are directed to solving the issues relating to one or more of the problems presented in the prior art, as well as providing additional features that will become readily apparent by reference to the following detailed description when taken in conjunction with the accompanied drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the invention.

In one aspect provides a system comprising at least one processor operatively coupled with a datastore, the at least one processor configured to: receive, from a flow cytometer, a flow cytometry data matrix characterizing a tube comprising leukemia cells, wherein the tube is associated with a sample; convert the flow cytometry data matrix into a tube linear vector; feed the tube linear vector into a subtyping classifier for labeling subtypes; and train said classifier to provide classified subtypes of leukemia cells, wherein the flow cytometry data matrix comprising FSC-H, FSC-A, FSC-W, SSC-A, SSC-W, and SSC-H parameters.

In another aspect provides a method comprising receiving, from a flow cytometer, a flow cytometry data matrix characterizing a tube comprising leukemia cells, wherein the tube is associated with a sample; converting the flow cytometry data matrix into a tube linear vector; feeding the tube linear vector into a subtyping classifier for labeling subtypes; and training said classifier to provide classified subtypes of leukemia cells, wherein the flow cytometry data matrix comprising FSC-H, FSC-A, FSC-W, SSC-A, SSC-W, and SSC-H parameters.

In yet another aspect provides a method performed by a computing system disclosed herein for classification of a flow cytometry data associated with leukemia cells, comprising: (a) receiving a flow cytometry data matrix characterizing a tube, wherein the tube is associated with a sample; (b) converting the flow cytometry data matrix into a tube linear vector; (c) feeding the tube linear vector into a trained subtyping classifier after step (4) in the system disclosed herein; (d) creating a visualization plot by a decision score system to provide classified subtypes of said sample leukemia cells.

### BRIEF DESCRIPTION OF THE DRAWINGS

Various exemplary embodiments of the invention are described in detail below with reference to the following Figures. The drawings are provided for purposes of illustration only and merely depict exemplary embodiments of the invention. These drawings are provided to facilitate the reader's understanding of the invention and should not be considered limiting of the breadth, scope, or applicability of the invention. It should be noted that for clarity and ease of illustration these drawings are not necessarily drawn to scale.

FIG. 1 provides an exemplary system diagram illustrating features of automated classification of subtyping leukemia cells.

FIG. 2 shows an exemplary block diagram of a computing device.

FIG. 3 is a block diagram that illustrates an exemplary subtyping classification process.

FIG. 4A/B show analysis results using an exemplary classifier processed with all 24 parameters (4A) or only 6 FC parameters (4B).

### DETAILED DESCRIPTION

Manual data analysis of flow cytometry (FC) data is laborious. Artificial intelligence (AI) has the potential to dramatically increase efficiency of FC data analysis. In accordance with the present invention, a method and/or a system utilized machine learning to build models that could rapidly distinguish between broad subtypes of acute leukemia and non-neoplastic pancytopenia are realized.

Flow cytometry is a technique used to detect and measure physical and chemical characteristics of a population of cells or particles. In this process, a sample containing cells or particles is suspended in a fluid and injected into the flow cytometer instrument. The sample is focused to ideally flow one cell at a time through a laser beam, where the light scattered is characteristic to the cells and their components. Cells are often labeled with fluorescent markers, so light is absorbed and then emitted in a band of wavelengths.

A flow cytometer has five main components: a flow cell, a measuring system, a detector, an amplification system, and a computer for analysis of the signals. The flow cell has a liquid stream (sheath fluid), which carries and aligns the cells so that they pass single file through the light beam for sensing. The measuring system commonly uses measurement of impedance (or conductivity) and optical systems—lamps (e.g., mercury, xenon); high-power water-cooled lasers (e.g., argon, krypton, dye laser); low-power air-cooled lasers (eg., argon (488 nm), red-HeNe (633 nm), green-HeNe, HeCd (UV)); diode lasers (blue, green, red, violet) resulting in light signals. The detector and analog-to-digital conversion (ADC) system converts analog measurements of forward-scattered light (FSC) and side-scattered light (SSC) as well as dye-specific fluorescence signals into digital signals that can be processed by a computer.

The data generated by flow-cytometers can be plotted in a single dimension, to produce a histogram, or in two-dimensional dot plots or even in three dimensions. The regions on these plots can be sequentially separated, based on fluorescence intensity, by creating a series of subset extractions, termed “gates.” Specific gating protocols exist for diagnostic and clinical purposes especially in relation to hematology. Individual single cells are often distinguished from cell doublets or higher aggregates by their “time-of-flight” (denoted also as a “pulse-width”) through the narrowly focused laser beam.

Forward scatter (FSC) and side scatter (SSC) gates are commonly used in gating. FSC vs SSC can be used to identify cells of interest based on size and granularity (complexibility). In general, FSC and SSC parameters are typically used to standardize the data from other parameters, especially the markers used in determining subtyping of cells in the traditional flow cytometry data analysis.

The invention is realized for example by utilizing a 4-category classification algorithms using FCS files acquired on BD FACSCanto II from e.g., 592 bone marrows with acute lymphoblastic leukemia, acute myeloid leukemia, acute promyelocytic leukemia and specimen data from patients with cytopenias found not to be attributable to a hematologic neoplasm (i.e. non-neoplastic pancytopenia).

Various exemplary embodiments of the invention are described below with reference to the accompanying figures to enable a person of ordinary skill in the art to make and use the invention. As would be apparent to those of ordinary skill in the art, after reading the present disclosure, various changes or modifications to the examples described herein can be made without departing from the scope of the invention. Thus, the present invention is not limited to the exemplary embodiments and applications described and illustrated herein. Additionally, the specific order or hierarchy of steps in the methods disclosed herein are merely exemplary approaches. Based upon design preferences, the specific order or hierarchy of steps of the disclosed methods or processes can be rearranged while remaining within the scope of the present invention. Thus, those of ordinary skill in the art will understand that the methods and techniques disclosed herein present various steps or acts in a sample order, and the invention is not limited to the specific order or hierarchy presented unless expressly stated otherwise.

In accordance with the practice of the current invention, the study sample set may be utilized for training and validation of the hematological abnormality classifier. Accordingly, the sample study set is a set of samples with known outcome information (e.g., a set of outcome labels or an outcome label set characterizing individual outcomes for each of the samples). This known outcome information may be utilized to train the hematological abnormality classifier (e.g., train the hematological abnormality classifier via supervised machine learning based on the known outcome information of the training sample set) and to validate the hematological abnormality classifier (e.g., validate the hematological abnormality classifier via determining the accuracy of the hematological abnormality classifier based on the known outcome information of the training sample set). This outcome information may include labels that indicate whether each sample includes a diagnosis of abnormal or normal

In contrast with the manual data analysis of FC analysis approaches for classification of subtyping leukemia cells, a reliable automated FC data analysis can improve healthcare quality by providing rapid clinical decision diagnosis and support. Accordingly, systems and methods in accordance with various embodiments include automated hematological abnormality detection that utilizes a hematological abnormality classifier for a multi-dimensional MFC phenotype trained using, for example, support vector machines (SVM) after gaussian mixture model (GMM) modeling. In some embodiments, this hematological abnormality classifier represents a supervised machine learning (SML) technique in analyzing a MFC dataset to develop an automated MFC interpretation for detecting MRD objectively in AML and MDS patients. SML refers to a branch of artificial intelligence (AI) that describes learning from data and expert provided labels to generate reliable automated inference. A non-limited exemplary 4-category classification algorithms achieved a 0.941 accuracy and 0.996 area under receiver operating characteristic curve. A model trained with only 6 parameters performed nearly as well as the model trained with all 24 parameters (See Table 1).

In some embodiments provide a system comprising at least one processor operatively coupled with a datastore, the at least one processor configured to: receive, from a flow cytometer, a flow cytometry data matrix characterizing a tube comprising leukemia cells, wherein the tube is associated with a sample; convert the flow cytometry data matrix into a tube linear vector; feed the tube linear vector into a subtyping classifier for labeling subtypes; and train said classifier to provide classified subtypes of leukemia cells, wherein the flow cytometry data matrix comprising FSC-H, FSC-A, FSC-W, SSC-A, SSC-W, and SSC-H parameters. In certain embodiments, the flow cytometry data matrix further comprises one or more marker parameters. In some embodiments, the classified subtypes of leukemia cells are acute leukemia and pancytopenia without hematologic malignancy. In certain embodiments, the classified subtypes of leukemia cells are acute lymphoblastic leukemia (ALL), acute myeloid leukemia (AML), acute promyelocytic leukemia (APL), and pancytopenia without hematologic malignancy. In some embodiments, the tube linear vector is a Fisher-encoding linear vector. In some embodiments, the at least one processor is further configured to determine an outcome for a new sample based on applying the new sample flow cytometry data matrix to the classifier. In certain embodiments, a flow cytometry data matrix of the new sample is converted into a tube linear vector and the tube linear vector is fed into the subtyping classifier after step (4) to provide a classified subtype of the new sample leukemia cells. In certain embodiments, the sample is derived from blood, mucus, bone marrow, or other body fluids from a person. In some embodiments, the at least one processor is configured to convert the flow cytometry data matrix into the tube linear vector using Fisher vector encoding and a gaussian mixture model distribution.

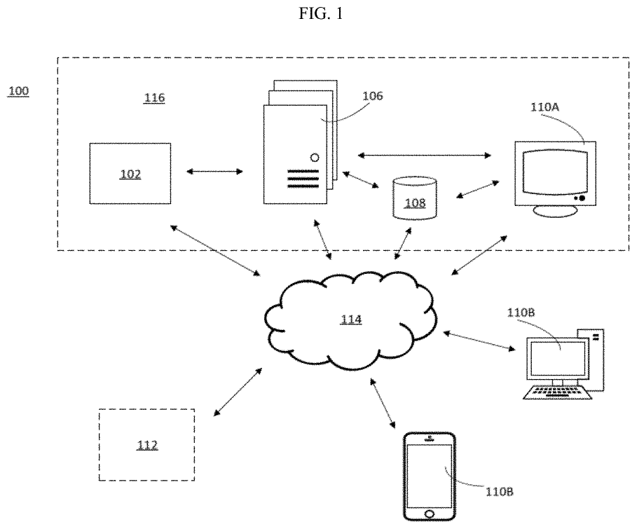

FIG. 1 provides an exemplary system diagram illustrating features of automated classification of subtyping leukemia cells 100. Said system 100 may comprise a flow cytometer 102 (e.g., an FC device), a detection server 106 (implemented as one or more servers), a datastore 108, a local user device 110A, remote user devices 110B, and an optional remote flow cytometer 112 (e.g., a remote FC device). In certain embodiments, each of the flow cytometer 102, detection server 106, datastore 108, local user device 110A, remote user devices 110B, and remote flow cytometer 112 may be connected via a network 114 (e.g., the Internet) or via local connections (e.g., communications interfaces).

In some embodiments, the functionality of each of the detection server 106, datastore 108, and local user device 110 may be implemented in a single remote server and/or locally on a user device. In further embodiments, the functionality of each of the flow cytometer 102, detection server 106, datastore 108, and local user device 110 may be implemented in a single flow cytometer and referred to as a combined flow cytometer 116 (e.g., within a single housing). In some embodiments, each of each of the flow cytometer 102, detection server 106, datastore 108, and local user device 110 may be communicatively coupled with each other directly. Also, the detection server 106, in whole or in part, may be communicatively coupled over the network 114 to a variety of external devices. These external devices may include, for example, the remote user devices 110B and/or remote flow cytometer 112.

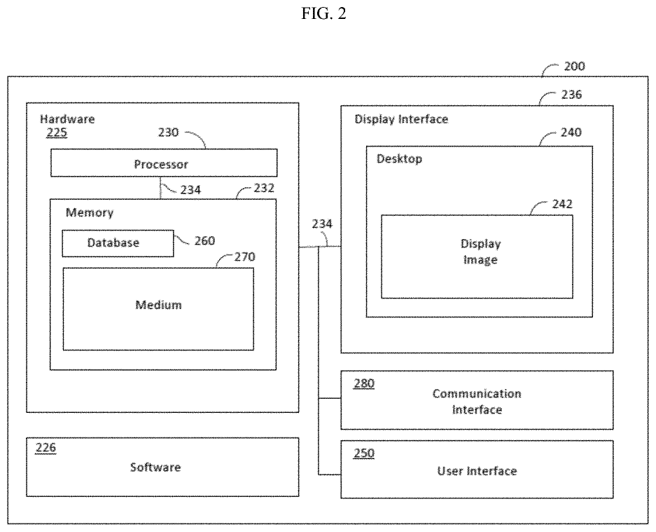

FIG. 2 shows an exemplary block diagram of a computing device 200. The computing device 200 may represent exemplary components of a particular flow cytometer (whether remote or local), detection server, and/or user device (whether remote or local). In some embodiments, the computing device 200 includes a hardware unit 225 and software 226. Software 226 can run on hardware unit 225 (e.g., the processing hardware unit) such that various applications or programs can be executed on hardware unit 225 by way of software 226. In some embodiments, the functions of software 226 can be implemented directly in hardware unit 225 (e.g., as a system-on-a-chip, firmware, field-programmable gate array (“FPGA”), etc.). In some embodiments, hardware unit 225 includes one or more processors, such as processor 230. In some embodiments, processor 230 is an execution unit, or “core,” on a microprocessor chip. In some embodiments, processor 230 may include a processing unit, such as, without limitation, an integrated circuit (“IC”), an ASIC, a microcomputer, a programmable logic controller (“PLC”), and/or any other programmable circuit. Alternatively, processor 230 may include multiple processing units (e.g., in a multi-core configuration). The above examples are exemplary only, and, thus, are not intended to limit in any way the definition and/or meaning of the term “processor.” Hardware unit 225 also includes a system memory 232 that is coupled to processor 230 via a system bus 234. Memory 232 can be a general volatile RAM. For example, hardware unit 225 can include a 32 bit microcomputer with 2 Mbit ROM and 64 Kbit RAM, and/or a number of GB of RAM. Memory 232 can also be a ROM, a network interface (NIC), and/or other device(s).

In some embodiments, the system bus 234 may couple each of the various system components together. It should be noted that, as used herein, the term “couple” is not limited to a direct mechanical, communicative, and/or an electrical connection between components, but may also include an indirect mechanical, communicative, and/or electrical connection between two or more components or a coupling that is operative through intermediate elements or spaces. The system bus 234 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, optionally, the computing device 200 can also include at least one media output component or display interface 236 for use in presenting information to a user. Display interface 236 can be any component capable of conveying information to a user and may include, without limitation, a display device (not shown) (e.g., a liquid crystal display (“LCD”), an organic light emitting diode (“OLED”) display, or an audio output device (e.g., a speaker or headphones). In some embodiments, computing device 200 can output at least one desktop, such as desktop 240. Desktop 240 can be an interactive user environment provided by an operating system and/or applications running within computing device 200, and can include at least one screen or display image, such as display image 242. Desktop 240 can also accept input from a user in the form of device inputs, such as keyboard and mouse inputs. In some embodiments, desktop 240 can also accept simulated inputs, such as simulated keyboard and mouse inputs. In addition to user input and/or output, desktop 240 can send and receive device data, such as input and/or output for a FLASH memory device local to the user, or to a local printer.

In some embodiments, the computing device 200 includes an input or a user interface 250 for receiving input from a user. User interface 250 may include, for example, a keyboard, a pointing device, a mouse, a stylus, a touch sensitive panel (e.g., a touch pad or a touch screen), a gyroscope, an accelerometer, a position detector, and/or an audio input device. A single component, such as a touch screen, may function as both an output device of the media output component and the input interface. In some embodiments, mobile devices, such as tablets, can be used.

In some embodiments, the computing device 200 can include a database 260 within memory 232, such that various information can be stored within database 260. Alternatively, in some embodiments, database 260 can be included within a remote datastore (not shown) or a remote server (not shown) with file sharing capabilities, such that database 260 can be accessed by computing device 200 and/or remote end users. In some embodiments, a plurality of computer-executable instructions can be stored in memory 232, such as one or more computer-readable storage medium 270 (only one being shown in FIG. 2). Computer-readable storage medium 270 includes non-transitory media and may include volatile and nonvolatile, removable and non-removable mediums implemented in any method or technology for storage of information such as computer-readable instructions, data structures, program modules or other data. The instructions may be executed by processor 230 to perform various functions described herein.

In the example of FIG. 2, in some embodiments, the computing device 200 is a communication device, a storage device, or any device capable of running a software component. For non-limiting examples, the computing device 200 can be but is not limited to a flow cytometer, a server machine, smartphone, a laptop PC, a desktop PC, a tablet, a Google's Android device, an iPhone, an iPad, and a voice-controlled speaker or controller.

The computing device 200 has a communications interface 280, which enables the computing devices to communicate with each other, the user, and other devices over one or more communication networks following certain communication protocols, such as TCP/IP, http, https, ftp, and sftp protocols. Here, the communication networks can be but are not limited to, the Internet, an intranet, a wide area network (WAN), a local area network (LAN), a wireless network, Bluetooth, WiFi, and a mobile communication network.

In some embodiments, the communications interface 280 may include any suitable hardware, software, or combination of hardware and software that is capable of coupling the computing device 200 to one or more networks and/or additional devices. The communications interface 280 may be arranged to operate with any suitable technique for controlling information signals using a desired set of communications protocols, services or operating procedures. The communications interface 280 may comprise the appropriate physical connectors to connect with a corresponding communications medium, whether wired or wireless.

A network may be utilized as a vehicle of communication. In various aspects, the network may comprise local area networks (LAN) as well as wide area networks (WAN) including without limitation the Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules may communicate in accordance with a number of wired protocols. Examples of wired protocols may comprise Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in some aspects, the communications interface 280 may comprise one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 280 may comprise a wireless interface comprising one or more antennas, transmitters, receivers, transceivers, amplifiers, filters, control logic, and so forth.

In various aspects, the communications interface 280 may provide data communications functionality in accordance with a number of protocols. Examples of protocols may comprise various wireless local area network (WLAN) protocols, including the Institute of Electrical and Electronics Engineers (IEEE) 802.xx series of protocols, such as IEEE 802.11a/b/g/n, IEEE 802.16, IEEE 802.20, and so forth. Other examples of wireless protocols may comprise various wireless wide area network (WWAN) protocols, such as GSM cellular radiotelephone system protocols with GPRS, CDMA cellular radiotelephone communication systems with 1xRTT, EDGE systems, EV-DO systems, EV-DV systems, HSDPA systems, and so forth. Further examples of wireless protocols may comprise wireless personal area network (PAN) protocols, such as an Infrared protocol, a protocol from the Bluetooth Special Interest Group (SIG) series of protocols, including Bluetooth Specification versions v1.0, v1.1, v1.2, v2.0, v2.0 with Enhanced Data Rate (EDR), as well as one or more Bluetooth Profiles, and so forth. Yet another example of wireless protocols may comprise near-field communication techniques and protocols, such as electro-magnetic induction (EMI) techniques. An example of EMI techniques may comprise passive or active radio-frequency identification (RFID) protocols and devices. Other suitable protocols may comprise Ultra Wide Band (UWB), Digital Office (DO), Digital Home, Trusted Platform Module (TPM), ZigBee, and so forth.

In some embodiments, the flow cytometer can process with up to 17 or ≥17 fluorescence markers simultaneously, in addition to 6 side and forward scattering parameters. Therefore, the data may include up to 17 or at least 17, 18, 19, 20, 21, 22, 23, or more channels.

In some embodiments, the flow cytometer may analyze a tube of a sample and produce a flow cytometry data matrix as an output (e.g., as flow cytometry data). This flow cytometry data matrix may be in, for example, in at least two, three, four, five, six, or seven dimensions. Accordingly, the multidimensional flow cytometry data may comprise data from one or more of the following signals: forward scatter (FSC) signals, side scatter (SSC) signals, or fluorescence signals. Characteristics of the signals (e.g., amplitude, frequency, amplitude variations, frequency variations, time dependency, space dependency, etc.) may be treated as dimensions as well. In some embodiments, the fluorescence signals comprise red fluorescence signals, green fluorescence signals, or both. However, any fluorescence signals with other colors may be included in various embodiments.

In certain embodiments, the flow cytometry data matrix may be presented in 2-dimensional matrix form with individual samples for training, validation, or test in columns and features presented in rows. This flow cytometry data matrix may be exported from the flow cytometer in the form of standard format flow cytometry standard (FCS) files.

In some embodiments, automated classification of subtypes of leukemia cells may involve using of a classifier to classify selected and/or detectable subtypes of leukemia cells. This subtyping classifier may be trained to operate on processed FC data. This processed FC data may be data produced by a flow cytometer (e.g., flow cytometry data) that has been processed (e.g., transformed or converted) into a format usable by the subtyping classifier. In some embodiments, the data produced by flow cytometry data, may be a flow cytometer data matrix. In some embodiments, the data is transformed to Fisher-encoding linear vector. Also, the processed FC data may be a high dimensional vector. In some embodiments, the vector and label (subtypes) are fed into neural network, or other machine learning algorism to train the classifier. In some embodiments, the training data set is an assembly of high dimensional vectors associated with samples. Also, once trained, the subtyping classifier may be able to classify new processed FC data to identify subtypes of leukemia cells.

In a typical setting to apply the present invention involves the suspicious lab result, or further clarification of the process lab results where the doctor then orders BM flow subject to machine learning involved classification. The classification, in some embodiments, provide subtyping acute leukaemia malignant cells (within AML, APL, ALL for examples) and non-malignant pancytopenia cells. With the fast and accurate subtyping results, a doctor may use different chemotherapy protocol to treat patient accordingly.

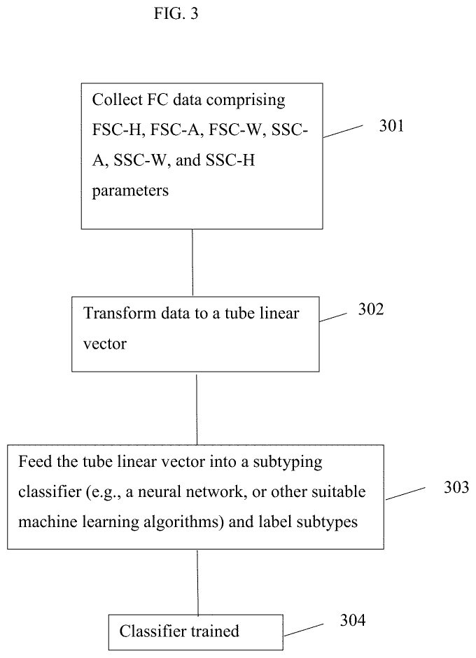

FIG. 3 is a block diagram that illustrates an exemplary subtyping classification process. Samples are measured with a panel of different suitable markers/parameters comprising all the FSC and SSC parameters (i.e., FSC-H, FSC-A, FSC-W, SSC-A, SSC-W, and SSC-H).

The subtyping classifier may be performed at an automated classification of subtyping of a leukaemia cells system, as illustrated herein. The automated classification of subtyping leukaemia cell system may comprise at least one of a flow cytometer, a detection server, a datastore, and a user device. In certain embodiments, the automated system may be implemented within a single housing. It is noted that the subtyping classification process illustrated in FIG. 3 is merely an example and not intended to limit the present disclosure. Accordingly, it is understood that additional operations (e.g., blocks) may be provided before, during, and after the subtyping classification process, certain operations may be omitted, certain operations may be performed concurrently with other operations, and that some other operations may only be briefly described herein.

First, sample tubes are prepared for a flow cytometer. Each tube is subject to a panel of different suitable markers comprising all the FSC and SSC parameters for collection in Step 301. In step 302, the data generated and collected therefrom then is transformed to a tube linear vector, e.g., a Fisher-encoding linear vector. Next, in step 303, the tube linear vector is fed into a subtyping classifier such as a neural network, or other suitable machine learning algorithms to label subtypes. In Step 304, the classifier is trained. See FIG. 3. With the included trained classifier in the system for classification of a new patient's FC data, the classification results are displayed in a visualization plot for a doctor to determine the best suitable treatments.

In certain embodiments, a study sample set may include from about 1000 to about 2000 or more samples of acute leukemia patients such as AML, APL, or ALL. Each sample may be associated with a single patient. Each sample may be represented by multiple tubes (e.g., multiple FC data points), where each tube may be a discrete input into a flow cytometer. For example, a study sample set of about 1000 to about 2000 samples (e.g., patients) may include a range of about 4000 to about 7000 tubes (e.g., FC data points).

In some embodiments provide a method, comprising receiving, from a flow cytometer, a flow cytometry data matrix characterizing a tube comprising leukemia cells, wherein the tube is associated with a sample; converting the flow cytometry data matrix into a tube linear vector; feeding the tube linear vector into a subtyping classifier for labeling subtypes; and training said classifier to provide classified subtypes of leukemia cells, wherein the flow cytometry data matrix comprising FSC-H, FSC-A, FSC-W, SSC-A, SSC-W, and SSC-H parameters. In certain embodiments, the classified subtypes of leukemia cells are acute leukemia and pancytopenia without hematologic malignancy. In certain embodiments, the classified subtypes of leukemia cells are acute lymphoblastic leukemia (ALL), acute myeloid leukemia (AML), acute promyelocytic leukemia (APL), and pancytopenia without hematologic malignancy. In some embodiments, the tube linear vector is a Fisher-encoding linear vector.

### Examples

4-category acute leukemia classification were developed with suitable algorithms using FCS files acquired on BD FACSCanto II from 592 bone marrows with acute lymphoblastic leukemia (ALL), acute myeloid leukemia (AML), acute promyelocytic leukemia (APL), and pancytopenia without hematologic malignancy. Diagnoses were based on routine FC, morphology, cytogenetic, molecular and clinical findings. Gaussian mixture models (GMM) were built using raw fluorescence intensity for the antibody-fluorochrome conjugates employed in ≥90% of specimens for each of the four categories and light scatter parameters (i.e., FSC-H, FSC-A, FSC-W, SSC-A, SSC-W, and SSC-H). The gradient of GMM parameters was computed using Fisher vectorization to derive a high dimensional representation for the support vector machine for AI-classification.

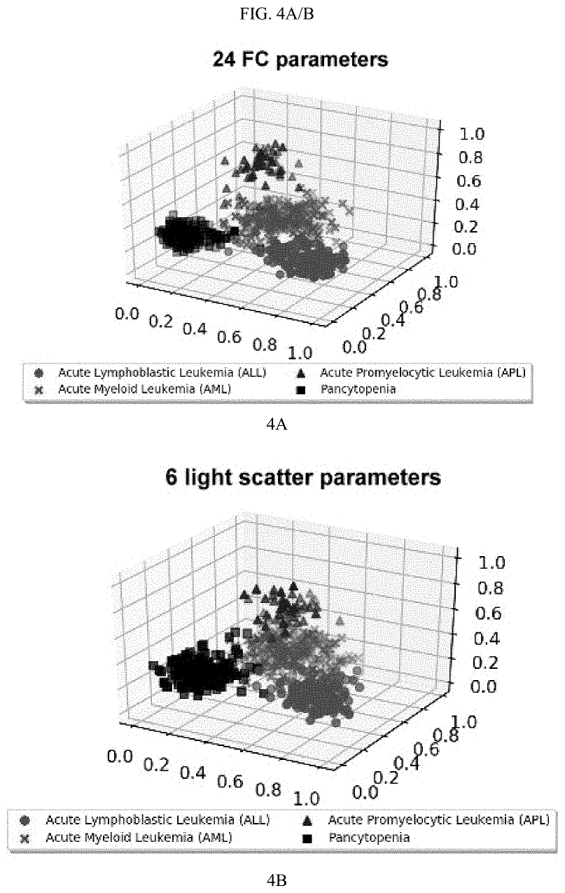

Results: The method utilizing the suitable algorithms disclosed herein for a 4-category classification to achieve a 0.941 accuracy and 0.996 area under receiver operating characteristic curve with the full panel (i.e., 24 parameters). However, surprisingly, a model trained with the 6 light scatter parameters (i.e., FSC-H, FSC-A, FSC-W, SSC-A, SSC-W, and SSC-H) performed nearly as good as the model trained with all 24 parameters (See Table 1, FIG. 4A and FIG. 4B).

TABLE 1
Classification performance of machine learning models
developed using either all 24 or 6 FC parameters.

[symbol]

| Variables in model | ACC | AUC | Specificity range | Sensitivity range |
|---|---|---|---|---|
| 24 FC parameters | 0.941 | 0.996 | 0.963-1.000 | 0.904-0.966 |
| 6 FC parameters | 0.931 | 0.989 | 0.952-0.998 | 0.904-0.943 |

Abbreviations:
ACC - accuracy;
AUC - area under ROC curve [symbol]
indicates data missing or illegible when filed

FIG. 4A/B provide exemplary visualization plots via principal component analysis using 3 best decision scores of the 4-category classification models with all 24 parameters (4A) or only with physical light scatter property parameters (i.e., the FSC and SSC parameters). Each dot represents an individual specimen and different icons indicate the diagnosis. It is clearly shown that the visualization plots using the non-marker type 6 light scatter parameters (FSC-H, FSC-A, FSC-W, SSC-A, SSC-W, and SSC-H), which are corresponding to simple forward scatter and side scatter gates, provides similar and satisfactory results (see FIG. 4B) in comparison with ones from the all marker inclusive 24 parameters (FIG. 4A). Thus, in some embodiments, the invention system and method only require said FSC and SSC parameters.

In some embodiments provide a method to provide the visualization 3-D plots resulted from the comparison of a new patient flow cytometry data with the selected databases. The exemplary procedure may be:
1. Compare a new patient flow cytometry data comprising said 6 light scatter parameters with a selected databank;
2. Using invention classification algorithms (e.g., 4-category classification algorithms disclosed herein) to create visualization plots via principal component analysis using a decision score system (e.g., 3 best decision scores) of the classification models;
3. Physician gives a suitable treatment based on a treatment guideline in view of the visualization plots;
4. If no visualization plots are given due to unacceptable decision scores, physician may order traditional 2-D plots using additional FC parameters from another tube of patient samples; and/or
5. Apply the flow cytometry data resulted from a second tube to the selected databank for comparison under the invention classification algorithms;
6. Create visualization plots via principal component analysis using a decision score system (e.g., 3 best decision scores) of the classification models;
7. Physician gives a suitable treatment based on a treatment guideline in view of the visualization plots. If needed, repeat steps 4-7.

Each sample may be represented by multiple tubes (e.g., multiple FC data points), where each tube may be a discrete input into a flow cytometer. In certain embodiments, these samples of the new sample set may be the same type of sample as that of the study sample set. For example, these samples may be blood, mucus, or bone marrow from a person (e.g., a patient). In preparation for processing by the flow cytometer, the samples may be preprocessed by a immunophenotyping panel consisting of a set of markers and antibodies.

In some embodiments provide a system comprising at least one processor operatively coupled with a datastore, the at least one processor configured to: receive, from a flow cytometer, a flow cytometry data matrix characterizing a tube comprising leukemia cells, wherein the tube is associated with a sample; convert the flow cytometry data matrix into a tube linear vector such as Fisher-encoding linear vector; feed the tube linear vector and label of subtypes into a subtyping classifier; and train said classifier based on the training data set to provide subtypes of leukemia cells. In certain embodiments, the at least one processor is further configured to: determine an outcome for a new sample based on applying the classifier to the new sample. In certain embodiments, the at least one processor is further configured to: determine an outcome for a new sample based on applying the classifier to a new single sample high dimensional vector associated with the new sample. In certain embodiments, the at least one processor is further configured to: determine an outcome for a new sample based on applying the classifier to a new single sample high dimensional vector associated with the new sample. In some embodiments, the sample is derived from blood, mucus, bone marrow, or other body fluids from a person. In certain embodiments, the at least one processor is further configured to: convert the flow cytometry data matrix into the tube linear vector using Fisher vector encoding and a gaussian mixture model distribution.

In some embodiments provide a method performed by a computing system disclosed herein for classification of a flow cytometry data associated with leukemia cells, comprising: (a) receiving a flow cytometry data matrix characterizing a tube, wherein the tube is associated with a sample (i.e., a new sample); (b) converting the flow cytometry data matrix into a tube linear vector; (c) feeding the tube linear vector into a trained subtyping classifier after step (4) in the system disclosed herein; (d) creating a visualization plot by a decision score system to provide classified subtypes of said sample leukemia cells. In some embodiments, the sample is derived from blood, mucus, bone marrow, or other body fluids from a person. In some embodiments, the at least one processor is further configured to convert the flow cytometry data matrix into the tube linear vector using Fisher vector encoding and a gaussian mixture model distribution.

While various embodiments of the invention have been described above, it should be understood that they have been presented by way of example only, and not by way of limitation. Likewise, the various diagrams may depict an example architectural or configuration, which are provided to enable persons of ordinary skill in the art to understand exemplary features and functions of the invention. Such persons would understand, however, that the invention is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two, which can be designed using source coding or some other technique), various forms of program or design code incorporating instructions (which can be referred to herein, for convenience, as “software” or a “software module), or combinations of both. To clearly illustrate this interchangeability of hardware and software, various illustrative components, blocks, modules, circuits, and steps have been described above generally in terms of their functionality. Whether such functionality is implemented as hardware, firmware or software, or a combination of these technique, depends upon the particular application and design constraints imposed on the overall system. Skilled artisans can implement the described functionality in various ways for each particular application, but such implementation decisions should not be interpreted as causing a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the invention.

Additionally, memory or other storage, as well as communication components, may be employed in embodiments of the invention. It will be appreciated that, for clarity purposes, the above description has described embodiments of the invention with reference to different functional units and processors. However, it will be apparent that any suitable distribution of functionality between different functional units, processing logic elements or domains may be used without detracting from the invention. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A system, comprising:
at least one processor operatively coupled with a datastore, the at least one processor configured to:
(1) receive, from a flow cytometer, a flow cytometry data matrix characterizing a tube comprising leukemia cells, wherein the tube is associated with a sample;
(2) convert the flow cytometry data matrix into a tube linear vector;
(3) feed the tube linear vector into a subtyping classifier for labeling subtypes; and
(4) train said classifier to provide classified subtypes of leukemia cells, wherein the flow cytometry data matrix comprising FSC-H, FSC-A, FSC-W, SSC-A, SSC-W, and SSC-H parameters.

2. The system of claim 1, wherein the flow cytometry data matrix further comprises one or more marker parameters.

3. The system of claim 1, wherein the classified subtypes of leukemia cells are acute leukemia and pancytopenia without hematologic malignancy.

4. The system of claim 3, wherein the classified subtypes of leukemia cells are acute lymphoblastic leukemia (ALL), acute myeloid leukemia (AML), acute promyelocytic leukemia (APL), and pancytopenia without hematologic malignancy.

5. The system of claim 1, wherein the tube linear vector is a Fisher-encoding linear vector.

6. The system of claim 1, wherein the at least one processor is further configured to:
determine an outcome for a new sample based on applying the new sample flow cytometry data matrix to the classifier.

7. The system of claim 6, wherein a flow cytometry data matrix of the new sample is converted into a tube linear vector and the tube linear vector is fed into the subtyping classifier after step (4) to provide a classified subtype of the new sample leukemia cells.

8. The system of claim 7, wherein the sample is derived from blood, mucus, bone marrow, or other body fluids from a person.

9. The system of claim 1, wherein the at least one processor is configured to:
convert the flow cytometry data matrix into the tube linear vector using Fisher vector encoding and a gaussian mixture model distribution.

10. A method, comprising:
(1) receiving, from a flow cytometer, a flow cytometry data matrix characterizing a tube comprising leukemia cells, wherein the tube is associated with a sample;
(2) converting the flow cytometry data matrix into a tube linear vector;
(3) feeding the tube linear vector into a subtyping classifier for labeling subtypes; and
(4) training said classifier to provide classified subtypes of leukemia cells, wherein the flow cytometry data matrix comprising FSC-H, FSC-A, FSC-W, SSC-A, SSC-W, and SSC-H parameters.

11. The method of claim 10, wherein the classified subtypes of leukemia cells are acute leukemia and pancytopenia without hematologic malignancy.

12. The method of claim 11 wherein the classified subtypes of leukemia cells are acute lymphoblastic leukemia (ALL), acute myeloid leukemia (AML), acute promyelocytic leukemia (APL), and pancytopenia without hematologic malignancy.

13. The method of claim 10, wherein the tube linear vector is a Fisher-encoding linear vector.

14. A method performed by a system of claim 1 for classification of a flow cytometry data associated with leukemia cells, comprising:
(a) receiving a flow cytometry data matrix characterizing a tube, wherein the tube is associated with a sample;
(b) converting the flow cytometry data matrix into a tube linear vector;
(c) feeding the tube linear vector into a trained subtyping classifier after step (4) in claim 1;
(d) creating a visualization plot by a decision score system to provide classified subtypes of said sample leukemia cells.

15. The method of claim 14, wherein the sample is derived from blood, mucus, bone marrow, or other body fluids from a person.

16. The method of claim 14, wherein the at least one processor is further configured to:
convert the flow cytometry data matrix into the tube linear vector using Fisher vector encoding and a gaussian mixture model distribution.
